(19) United States
(12) Patent Application Publication
(10) Pub. No.: US 2017/0293060 A1
(43) Pub. Date: Oct. 12, 2017

(54) LIGHT-EMITTING DEVICE

(71) Applicant: PANASONIC INTELLECTUAL PROPERTY MANAGEMENT CO., LTD., Osaka (JP)

(72) Inventors: Shintaro HAYASHI, Hyogo (JP); Atsushi MOTOYA, Shiga (JP); Naoya IKENO, Osaka (JP); Motohide TOSHIKAWA, Kyoto (JP)

(21) Appl. No.: 15/483,782

(22) Filed: Apr. 10, 2017

(30) Foreign Application Priority Data
Apr. 12, 2016 (JP) 2016-079927

(51) Int. Cl. F21V 8/00; G09F 13/22; A63H 27/10; G09F 21/06; F21V 33/00; F21L 4/00

(52) U.S. Cl. CPC G02B 6/001; F21V 33/008; F21L 4/00; A63H 27/10; G09F 21/06; G09F 13/22; F21Y 2115/30

(57) ABSTRACT

A light-emitting device includes: a balloon, a light source disposed outside the balloon; and an optical fiber that connects the balloon and the light source and propagates light emitted by the light source. At least one of the balloon and the optical fiber becomes luminous by the light emitted by the light source.

### CROSS REFERENCE TO RELATED APPLICATION

This application claims the benefit of priority of Japanese Patent Application Number 2016-079927 filed on Apr. 12, 2016, the entire content of which is hereby incorporated by reference.

### BACKGROUND

### 1. Technical Field

The present disclosure relates to a light-emitting device.

### 2. Description of the Related Art

Luminaires whose light-emitting body is held up at a high place are being developed for the purpose of anti-disaster measures or advertisements. For example, Japanese Unexamined Patent Application Publication No. 2006-252869 discloses a luminaire whose light-source light bulb and balloon that houses the light bulb are supported by a support member.

### SUMMARY

With such a luminaire, the size of the support structure for holding up the light-emitting body at a high place is large. Therefore, there are problems that an installation area needs to be secured for the luminaire and the cost of the support structure needs to be reduced. There is also a problem that safety measures are needed against toppling of the luminaire.

The present disclosure provides a light-emitting device which easily holds up a luminous member at a high place.

A light-emitting device according to an aspect of the present disclosure is a light-emitting device including: a flying object; a light source disposed outside the flying object; and an optical fiber that connects the flying object and the light source and propagates light emitted by the light source. At least one of the flying object and the optical fiber becomes luminous by the light emitted by the light source.

According to the present disclosure, it is possible to provide a light-emitting device which easily holds up a luminous member at a high place.

### BRIEF DESCRIPTION OF DRAWINGS

The figures depict one or more implementations in accordance with the present teaching, by way of examples only, not by way of limitations. In the figures, like reference numerals refer to the same or similar elements.

FIG. 1 is an external view of a light-emitting device according to an embodiment;

FIG. 2 is a schematic view illustrating a configuration for causing a balloon to become luminous;

FIG. 3 is a schematic view illustrating a configuration for causing a balloon, which includes a light guide film on the surface, to become luminous;

FIG. 4 illustrates an example of forming letters using a portion of an optical fiber; and

FIG. 5 illustrates a light-emitting device used as a toy.

### DETAILED DESCRIPTION OF EMBODIMENT

Hereinafter, an embodiment will be described with reference to the drawings. It should be noted that the embodiment described below shows general or specific examples. The numerical values, shapes, materials, structural elements, and the arrangement and connection of the structural elements, etc., shown in the following embodiment are mere examples, and are therefore not intended to limit the present disclosure. Among the structural elements in the following embodiment, those not recited in any one of the independent claims indicating the broadest inventive concepts will be described as arbitrary structural elements.

It should be noted that each drawing is a schematic illustration and not necessarily a precise illustration. Furthermore, in the drawings, structural elements having substantially the same configuration are given the same reference signs, and overlapping description may be omitted or simplified.

### Embodiment

### [Configuration]

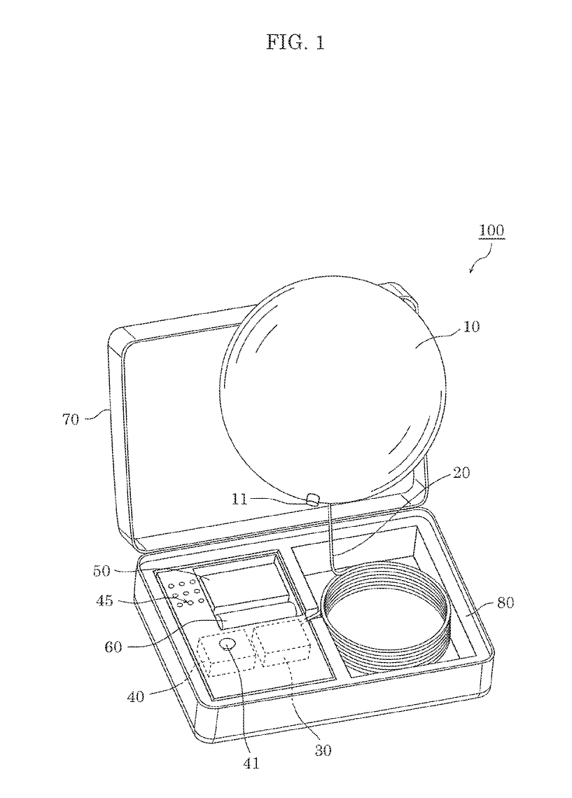

A configuration of a light-emitting device according to an embodiment will be described. FIG. 1 is an external view of a light-emitting device according to an embodiment.

As illustrated in FIG. 1, light-emitting device 100 according to an embodiment includes balloon 10, optical fiber 20, light source 30, controller 40, speaker 45, battery 50, gas cylinder 60, case 70, and cushioning material 80.

Light-emitting device 100 is a device that, in case of an emergency such as a disaster, makes notification of the location of a victim of the disaster or the location of an evacuation site, for example. The exterior appearance of light-emitting device 100 is like a suitcase, and each structural element of light-emitting device 100 is housed in case 70 when light-emitting device 100 is not in use.

When a user opens case 70 and presses button 41, balloon 10 is charged with gaseous helium contained in gas cylinder 60. As a result, balloon 10 inflates and flies. At least optical fiber 20 becomes luminous by light source 30 emitting light. Because the optical fiber connects light source 30 and balloon 10, balloon 10 does not rise farther than the length of optical fiber 20. Hereinafter, each structural element of light-emitting device 100 will be described.

Balloon 10 is a flying object that flies when filled (charged) with a gas lighter in weight than the air. Balloon 10 is formed using, for example, rubber such as natural rubber; however, balloon 10 may be formed using resin such as a vinyl compound, a polyester resin, a polyethylene resin, or a nylon resin. Balloon 10 may also be formed using paper. The shape of balloon 10 is, but not particularly limited to, spherical, for example. Balloon 10 is only required to have a size that gives buoyancy to lift optical fiber 20.

Balloon 10 is housed in case 70 in a shrunk state. Balloon 10 includes check valve 11 and is filled with gaseous helium by the gas cylinder through check valve 11. Check valve 11 reduces leak of the gaseous helium from balloon 10.

Optical fiber 20 is a string-like component that propagates (guides) light emitted by light source 30. In the embodiment, optical fiber 20 is a luminous fiber that becomes luminous by the light emitted by light source 30 and passing through optical fiber 20. That is to say, the primary purpose of optical fiber 20 is to become luminous, rather than to propagate light.

Optical fiber 20 includes a core portion that propagates light and a light-transmissive clad portion (outer sheath) that surrounds the core portion from the side. The base material of the core portion contains a light scattering material. This allows the side portion (the side surface) of optical fiber 20 to appear luminous when light is guided to the core portion. Although the core portion is formed using, for example, a light-transmissive acrylic resin, the material is not particularly limited. Furthermore, although the clad portion is formed using, for example, a light-transmissive fluorine resin, the material is not particularly limited.

Optical fiber 20 connects balloon 10 and light source 30. Specifically, one end portion of optical fiber 20 is connected to balloon 10, whereas the other end portion of optical fiber 20 is connected to the light exit of light source 30. Although optical fiber 20 is connected to each of balloon 10 and light source 30 using, for example, an adhesive, the connection method is not particularly limited. It should be noted that the one end portion of optical fiber 20 may be disposed inside or outside balloon 10.

The diameter of optical fiber 20 is, but not particularly limited to, φ1 mm approximately, for example. The length of optical fiber 20 is, but not particularly limited to, at least 15 m and at most 100 m, for example. It should be noted that the weight of optical fiber 20 having a diameter of φ1 mm and a length of 100 m approximately is about 10 g. The weight of optical fiber 20 therefore does not hinder balloon 10 from rising (flying).

Light source 30 emits light from the light exit toward the other end portion of optical fiber 20 based on the control by controller 40. Light source 30 is disposed outside balloon 10. The power source for light source 30 is battery 50. Light source 30 includes a laser diode as a light-emitting element, and emits laser light from the light exit. The laser light emitted from the light exit of light source 30 passes through optical fiber 20 (the core portion). At this time, optical fiber 20 itself appears luminous since the base material of the core portion contains a light scattering material.

The emission color of the laser light is, but not particularly limited to, blue, red, or green, for example. It should be noted that the luminosity factor of human eyes is highest near the wavelength of 555 nm (green). Thus, the visibility of optical fiber 20 can be increased by using green laser light and causing optical fiber 20 to become luminous in green. Green light has, for example, a peak wavelength of at least 500 nm and at most 570 nm.

Controller 40 turns light source 30 on, and supplies a gas from gas cylinder 60 to balloon 10 (opens a gas supply opening (valve) of gas cylinder 60). When button 41 is pressed by the user, controller 40 causes speaker 45 to output audio guidance. The audio guidance is to notify the user that balloon 10 will be inflated. After that, controller 40 turns light source 30 on, and starts supplying a gas from gas cylinder 60 to balloon 10.

Prior to button 41 being pressed, the gas supply opening (not illustrated in FIG. 1) of gas cylinder 60 and check valve 11 are connected. Check valve 11 has such a configuration that the connection with the gas supply opening is released when balloon 10 is inflated to some degree, due to the pressure (internal pressure) of balloon 10. Therefore, when balloon 10 is inflated to some degree, balloon 10 is automatically disconnected from the gas supply opening and starts to rise.

Controller 40 is specifically realized by a processor, a microcomputer, or a specialized circuit (or a combination thereof). Controller 40 may be realized by a combination of a processor, a microcomputer, and a specialized circuit.

Controller 40 may include a storage (memory) storing a control program to be executed by a processor. The power source for controller 40 is battery 50.

Speaker 45 outputs audio guidance based on the control by controller 40.

Battery 50 is a storage battery that functions as a power source for light source 30 and controller 40. A battery for a laptop computer, for example, may be used as battery 50. Using about three typical laptop-computer batteries as battery 50 enables light source 30 to continuously emit light for about 24 hours.

Gas cylinder 60 is a gas cylinder filled with gaseous helium. A commercially-available helium gas cylinder may be used as gas cylinder 60. Gas cylinder 60 is only required to be filled with a gas lighter in weight than the air.

Case 70 houses balloon 10, optical fiber 20, light source 30, controller 40, speaker 45, battery 50, gas cylinder 60, and cushioning material 80. Case 70 also functions as a weight that reduces the occurrence of light-emitting device 100 being blown away by the wind, for example. The weight of case 70 is about 10 kg, for example.

It should be noted that case 70 may include a caster to allow the user to move case 70. This allows the user to easily carry case 70 even when case 70 is heavy. Although case 70 is formed using, for example, metal such as duralumin, case 70 may be formed using resin.

Cushioning material 80 is a buffer material for protecting balloon 10, optical fiber 20, light source 30, controller 40, speaker 45, battery 50, and gas cylinder 60 that are housed in case 70. Although cushioning material 80 is formed using, for example, a urethane resin, the material is not particularly limited.

As described thus far, when button 41 is pressed by the user, light-emitting device 100 causes balloon 10 to rise by inflating balloon 10 with gaseous helium, and causes optical fiber 20 connecting balloon 10 and light source 30 to become luminous. Light-emitting device 100 can hold up (lift) optical fiber 20, which is a luminous member, at a high place by the buoyancy of balloon 10 while relatively heavy light source 30 is kept on the ground. That is to say, light-emitting device 100 can easily hold up optical fiber 20 at a high place.

### [Variation 1]

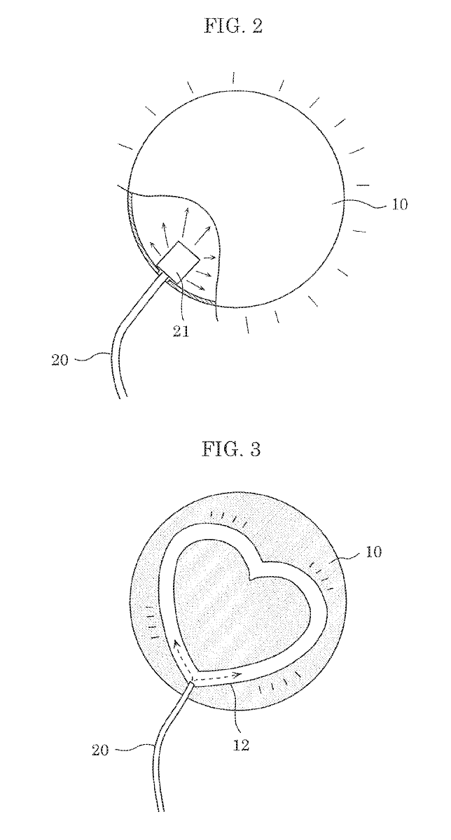

To increase the visibility of light-emitting device 100, balloon 10 may also become luminous. FIG. 2 is a schematic view illustrating a configuration for causing balloon 10 to become luminous.

As illustrated in FIG. 2, in order to cause balloon 10 to become luminous, one end portion of optical fiber 20 is disposed inside balloon 10. The one end portion of optical fiber 20 is provided with optical component 21 that diffuses light. Optical member 21 is a light-diffusing plate (a light-diffusing lens or a light-diffusing prism), for example. In order not to hinder balloon 10 from rising, optical member 21 may be lightweight.

Balloon 10 is formed using a light-transmissive material. This allows the light diffused by optical member 21 to be released through balloon 10, and thus balloon 10 appears luminous. It should be noted that when causing only optical fiber 20 to become luminous as described earlier, balloon 10 need not be light-transmissive.

In order to cause balloon 10 to become luminous more brightly, the inner surface of balloon 10 may be provided with a light-diffusing sheet, or the material of balloon 10 may contain a light-diffusing material such as silica particles.

It should be noted that when balloon 10 becomes luminous, optical fiber 20 may become luminous or non-luminous. That is to say, when balloon 10 becomes luminous, optical fiber 20 need not be a luminous fiber.

### [Variation 2]

Balloon 10 may become luminous by including a light guide film on the surface. Specifically, balloon 10 may become luminous by the light being emitted by light source 30, propagating through optical fiber 20, and entering the light guide film. FIG. 3 is a schematic view illustrating a configuration for causing balloon 10, which includes a light guide film on the surface, to become luminous.

Light guide film 12 is a film-like light guide plate adhered to the surface of balloon 10. Light guide film 12 is a sheet-like component obtained by performing microfabrication, such as providing prisms, on the surface of a light-transmissive film, and the surface of light guide film 12 becomes luminous by the light emitted from an end portion of optical fiber 20 entering an end surface of light guide film 12. Specifically, light guide film 12 is formed using a polycarbonate resin or an acrylic resin, for example.

Although light guide film 12 is provided on a portion of the surface of balloon 10, light guide film 12 may be provided on the entire surface of balloon 10. Furthermore, balloon 10 as a whole may be formed using elastic light guide film 12. In the example of FIG. 3, light guide film 12 is formed into the shape of a heart. Light guide film 12 may be formed into other shapes, or into letters or symbols. It should be noted that a portion of the surface of balloon 10 on which light guide film 12 is not provided does not becomes luminous.

### [Variation 3]

In order to increase the visibility of light-emitting device 100, a portion of luminous optical fiber 20 may be disposed along the surface of balloon 10. At this time, the portion of optical fiber 20 is bent into a predetermined shape and adhered to the surface of balloon 10 using an adhesive. In this case, balloon 10 need not become luminous.

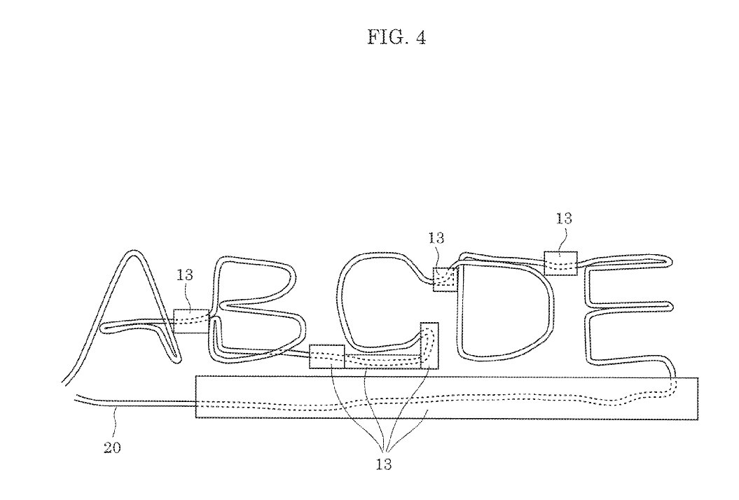

The predetermined shape is a figure such as a circle, but is not particularly limited. Here, a portion of optical fiber 20 may form a letter or a symbol by being bent into a predetermined shape. FIG. 4 illustrates an example of forming letters using a portion of optical fiber 20.

As illustrated in FIG. 4, optical fiber 20 can form letters by being bent in a single-stroke-drawing manner. Optical fiber 20 can form letters “ABCDE”, for example, and the letters become luminous by the optical fiber becoming luminous. With this, light-emitting device 100 can enable a person viewing balloon 10 to recognize the letters or symbols.

It should be noted that as illustrated in FIG. 4, portions of optical fiber 20 that need not become luminous may be covered by light shields 13. That is to say, a portion of optical fiber 20 may form a letter or a symbol by being bent into a predetermined shape and partially covered by light shield 13. This makes the letter or symbol appear clearly.

Although light shield 13 is, for example, an adhesive tape which does not transmit light and is formed using a material such as polyester, light shield 13 is not particularly limited. When light shield 13 is an adhesive tape, light shield 13 functions also as an adhesive for adhering (fixing) optical fiber 20 to the surface of balloon 10.

### [Advantageous Effects, Etc.]

As described above, light-emitting device 100 includes: balloon 10; light source 30 disposed outside balloon 10; and optical fiber 20 that connects balloon 10 and light source 30 and propagates light emitted by light source 30. At least one of balloon 10 and optical fiber 20 becomes luminous by the light emitted by light source 30. Balloon 10 is an example of the flying object.

With this, light-emitting device 100 can cause balloon 10 and optical fiber 20 to rise easily using balloon 10 (flying object), while relatively heavy light source 30 is kept on the ground. That is to say, it is possible to provide light-emitting device 100 which can easily hold up a luminous member at a high place.

Furthermore, optical fiber 20 may be a luminous fiber that becomes luminous by the light emitted by light source 30 passing through optical fiber 20.

With this, light-emitting device 100 can cause optical fiber 20 to function as a luminous member.

Furthermore, a portion of optical fiber 20 may be disposed along a surface of balloon 10 and bent into a predetermined shape.

With this, light-emitting device 100 can enable a person viewing balloon 10 to recognize the predetermined shape.

Furthermore, the portion of optical fiber 20 may form at least one of a letter and a symbol by being bent into the predetermined shape.

With this, light-emitting device 100 can enable a person viewing balloon 10 to recognize a letter or a symbol. Furthermore, the portion of optical fiber 20 may form at least one of a letter and a symbol by being bent into the predetermined shape and partially covered by light shield 13.

With this, light-emitting device 100 can make the letter or symbol formed by the optical fiber appear clearly. Furthermore, a surface of balloon 10 may include light guide film 12, and balloon 10 may become luminous by the light being emitted by light source 30, passing through optical fiber 20, and entering light guide film 12.

With this, light-emitting device 100 can cause balloon 10 to function as a luminous member.

Furthermore, light source 30 may emit green light, and at least one of balloon 10 and optical fiber 20 may become luminous in green.

With this, the visibility of balloon 10 or optical fiber 20 can be increased.

As described above, balloon 10 is an example of the flying object. That is to say, the flying object may be a balloon filled with a gas lighter in weight than air.

With this, light-emitting device 100 can cause balloon 10 and optical fiber 20 to rise easily using balloon 10. That is to say, it is possible to provide light-emitting device 100 which can easily hold up the luminous member at a high place.

Furthermore, light source 30 may include a laser diode. At least one of balloon 10 and optical fiber 20 may become luminous by laser light emitted by light source 30. With this, light-emitting device 100 can cause at least one of balloon 10 and optical fiber 20 to become luminous by laser light.

### Other Embodiments

Although a light-emitting device according to an embodiment has been described above, the present disclosure is not limited to the above embodiment.

For example, the purpose of the light-emitting device is not particularly limited. For example, the light-emitting device may be used as a luminaire. That is to say, the present disclosure may be realized as an illumination device.

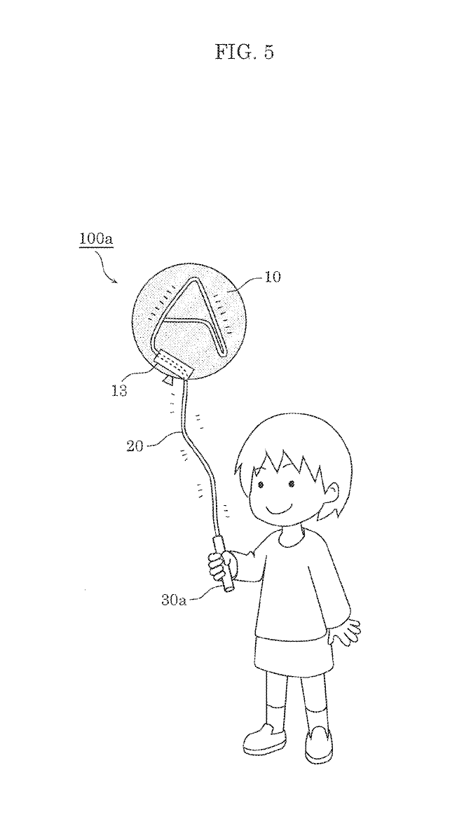

The light-emitting device may also be used as a toy. FIG. 5 illustrates the light-emitting device used as a toy.

Light-emitting device 100a illustrated in FIG. 5 includes balloon 10, light source 30a, and optical fiber 20 connecting light source 30a and balloon 10. Light source 30a is a laser light source miniaturized into a bar shape so that the user can hold. An optical system used for a laser pointer may be used as light source 30a, for example.

Optical fiber 20 is a luminous fiber, and becomes luminous by light emitted by light source 30a. In light-emitting device 100a, a portion of optical fiber 20 is disposed along the surface of balloon 10. The portion of optical fiber 20 forms a letter by being bent into a predetermined shape and partially covered by light shield 13. The color of light shield 13 may be the same as the color of balloon 10.

As with light-emitting device 100a described above, the present disclosure may be realized as a light-emitting device used as a toy.

Furthermore, although a balloon has been used as an example of the flying object in the above embodiment, the flying object is not limited to a balloon. For example, a kite or a drone may be used as the flying object.

For example, in the above embodiment, a letter or the like is formed by bending a luminous optical fiber on the surface of a non-luminous balloon; however, a letter or the like may be formed by bending a non-luminous optical fiber on the surface of a luminous balloon.

Furthermore, the optical fiber may be disposed along the inner surface of a balloon, rather than along the surface (outer surface) of a balloon. Likewise, the light guide film may also be included on the inner surface of a balloon, rather than on the surface (outer surface) of a balloon.

Moreover, the configuration of the light source described in the above embodiment is a mere example, and it is only necessary for the light source to cause at least one of a balloon and an optical fiber to become luminous. As long as such a requirement is met, a solid-state light-emitting element such as an LED, an inorganic electroluminescent element, and an organic electroluminescent element may be used for the light source.

Apart from the above, the present disclosure also encompasses embodiments obtained by making various modifications conceivable to a person of skill in the art to the above embodiment as well as embodiments implemented by arbitrarily combining the structural elements and the functions in the above embodiment within the scope of the essence of the present disclosure.

While the foregoing has described one or more embodiments and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A light-emitting device, comprising:
a flying object;
a light source disposed outside the flying object; and
an optical fiber that connects the flying object and the light source and propagates light emitted by the light source, wherein
at least one of the flying object and the optical fiber becomes luminous by the light emitted by the light source.

2. The light-emitting device according to claim 1, wherein
the optical fiber is a luminous fiber that becomes luminous by the light emitted by the light source passing through the optical fiber.

3. The light-emitting device according to claim 2, wherein
a portion of the optical fiber is disposed along a surface of the flying object and bent into a predetermined shape.

4. The light-emitting device according to claim 3, wherein
the portion of the optical fiber forms at least one of a letter and a symbol by being bent into the predetermined shape.

5. The light-emitting device according to claim 4, wherein
the portion of the optical fiber forms at least one of a letter and a symbol by being bent into the predetermined shape and partially covered by a light shield.

6. The light-emitting device according to claim 1, wherein
a surface of the flying object includes a light guide film, and the flying object becomes luminous by the light being emitted by the light source, passing through the optical fiber, and entering the light guide film.

7. The light-emitting device according to claim 1, wherein
the light source emits green light, and
at least one of the flying object and the optical fiber becomes luminous in green.

8. The light-emitting device according to claim 1, wherein
the flying object is a balloon filled with a gas lighter in weight than air.

9. The light-emitting device according to claim 1, wherein
the light source includes a laser diode, and
at least one of the flying object and the optical fiber becomes luminous by laser light emitted by the light source.
